(19) United States
(12) Patent Application Publication
(10) Pub. No.: US 2017/0270827 A1
(43) Pub. Date: Sep. 21, 2017

(54) Networked Sensory Enhanced Navigation System

(71) Applicants: Sumanth Channabasappa, Broomfield, CO (US); Michael Lynn Hess, Lakewood, CO (US); Channabasappa Gurukar Mallikarjuna, Bengaluru (IN); Kishore Nayak, Broomfield, CO (US)

(72) Inventors: Sumanth Channabasappa, Broomfield, CO (US); Michael Lynn Hess, Lakewood, CO (US); Channabasappa Gurukar Mallikarjuna, Bengaluru (IN); Kishore Nayak, Broomfield, CO (US)

(21) Appl. No.: 15/283,058

(22) Filed: Sep. 30, 2016

Related U.S. Application Data
(60) Provisional application No. 62/296,540, filed on Feb. 17, 2016.
(60) Provisional application No. 62/234,040, filed on Sep. 29, 2015.

(51) Int. Cl. G09B 21/00; A43B 3/00; A41D 1/00

(52) U.S. Cl. CPC G09B 21/007; A41D 1/002; A43B 3/0005

(57) ABSTRACT

A networked sensory enhanced navigation system enables direction of visually impaired users through complex environments. At least one user peripheral is disposed in networked communication to determine a current user location, potential future user locations, and any selected destination, relative dynamic landscape data informing a proximal environment. Landscape data is populated by access to a Geographic Data Store (“GDS”) wherein previously determined landscape data is storable and accessible. Landscape data is verifiable by local capture effective through third-party peripherals connected over network. The user is directed through the landscape along a designated path, or prevented from collision, by issuance of signal alarms communicative of instructions to the user.

### CROSS-REFERENCE TO RELATED APPLICATIONS

This nonprovisional claims the benefit of provisional application No. 62/296,540 filed on Feb. 17, 2016 and provisional application No. 62/234,040 filed on Sep. 29, 2015.

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Various apparatuses and systems have been devised to assist visually impaired individuals navigate real world environments and situations. Most provide for an elongate tool of some kind, wielded in hand to delimit a sphere of sensitivity beyond which the world at large remains largely unknown. Visually impaired users are thereby dependent on other people or guiding animals to effectively navigate through complex landscapes and environments.

However, in the present day, networked peripheral devices enable a digital apprehension of locations and the so-called “internet-of-things” enables collaboration of data sensed between everyday objects common throughout the modern environment. What is needed, then, is a networked sensory enhanced navigation system operational upon at least one user peripheral device disposed in networked communication within a proximal environment relative a user location, whereby a visually impaired user is directable by unique issuances of signal alarms through said proximal environment, along a designated path, or in avoidance of known or sensed objects, and thereby enabled unimpeded passage within the proximal environment.

### FIELD OF THE INVENTION

The present invention relates to a networked sensory enhanced navigation system devised to enable unimpeded passage of a visually impaired user through a proximal environment relative a sensed user location. The present networked sensory enhanced navigation system enables determination of a user location by connection with a Global Positioning System (“GPS”), by sensor fusion, and by location between transceivers as may be operative within the proximal environment. The user location is thus continuously determinable, and user velocity is thus calculable whereby future user locations are predictable. At least one user peripheral device is disposed in wireless networked communication with a Geographical Data Store (“GDS”) whereby landscape data is comprehensible and informative of the proximal environment. Landscape data may be generable from maps, blueprints of particular buildings (when the user is located inside), or other spatial data sets as accessible over network and storable to memory in the GDS. A user history of previous movements may likewise comprise spatial data storable as part of the GDS, accessible to assist in directing the user through the same proximal environment when desired.

Landscape data is further verifiable by local capture of landscape data whereby changes in landscape data are discoverable and verifiable, and the GDS is thereby updateable to accommodate said verification. Local capture of landscape data is effective through third-party peripheral devices, such as everyday objects disposed in network (the so-called “internet-of-things”) including, for example, vehicles traveling within the proximal environment, security cameras active within the proximal environment, traffic cameras active within the proximal environment, other participating peripheral devices found active within the proximal environment, as well as other sensors disposed in network and accessible over network, such as local thermometers, for example, as well as remotely based weather stations articulating data pertinent to the user location. Thus landscape data is dynamic and reflects real time (or approximately real time) stimuli as experienced at the user location.

Additional sensing means are contemplated as wearable on, or portable by, the user, whereby waveform transmissions, for example, as well as visual capture effective through portable cameras, say, enable Near Field Communication (“NFC”) with surrounding objects or determination of presence or absence of particular objects, as case may be.

Issuance of signal alarms enables communication of instructions to the user, whereby said user is directable through the proximal environment and prevented from collision with known or sensed objects. Signal alarms are contemplated in multiple forms, however an example embodiment discussed herein makes use of haptic stimuli to communicate directional instructions as well as spatial information to the user. A plurality of vibration motors is contemplated in one example embodiment, wearable or portable in contact with said user, whereby frequencies, amplitudes, and locations of vibrational stimuli upon the body of the user signal information regarding distance to proximal objects, for example, directional instructions, such as change of direction for example, or to indicate appropriate moments in time and space whereat particular movements should be undertaken (such as when crossing a road, for example).

The present networked sensory enhanced navigation system, therefore, enables visually impaired and other users who may be visually preoccupied, to travel through real world environments and changing landscapes in relative safety without said user visually apprehending said proximal environment.

### SUMMARY OF THE INVENTION

The present networked sensory enhanced navigation system has been devised to assist visually impaired users navigate through real world landscapes by determining a proximal environment relative a current user location, said proximal environment informed by updateable landscape data accessible over network from a Geographic Data Store (“GDS”) and through participating third-party peripheral devices verifying data in real time. The present networked sensory enhanced navigation system communicates signal alarms to direct the user through the proximal environment, said single alarms communicating instructions to the user, to avoid objects known and sensed as present in the proximal environment, hazards that may exist, and to avoid other users, along a designated path (when a destination is selected) from a current user location to a future user location, whereby visually impaired and visually occupied users are enabled safe travel.

The term “visually impaired” includes legally blind individuals, users requiring assistance seeing, as well as users who may not be viewing a landscape while traveling through said landscape (such as users wearing headsets, for example). In some embodiments, the present networked sensory enhanced navigation system is further usable by visually unimpaired users whereby landscape data is presentable by means of a Graphic User Interface (“GUI”) and said visually unimpaired users are enabled action to verify or update particular landscape data.

The present networked sensory enhanced navigation system, therefore, includes at least one peripheral device active in possession of a user. The at least one peripheral device is disposed in networked communication with a Global Positioning System (“GPS”) to continuously determine a user location. The user location may be verified, or otherwise determined, by triangulation between transceivers, such as cellular communications towers, for example, and by other means established in the art, including, for example, Near Field Communication (“NFC”) with everyday objects as may be disposed in network communication within the proximal environment.

The user location enables determination of the proximal environment pertinent to said user location. The proximal environment is comprised of landscape data that is accessed from a Geographic Data Store (“GDS”) wherein landscape data is storable to memory and accessible over network. The GDS may include maps, blueprints to particular buildings, schematics, and histories of user movements previously stored to memory whereby spatial relationships in particular places are maintained. GDS may likewise store geographic data captured previously by the user at least one peripheral device and/or by third-party peripherals determined to be active in the proximal environment. The GDS may further network with known traffic signals and traffic schedules.

Landscape data is verifiable and updateable in the GDS by capture of local data generated by third-party peripherals and everyday objects participating in the so-called “internet-of-things”. A plurality of sensors, therefore, is leveraged across the proximal environment and local environmental data (such as temperature, barometric pressure, relative humidity, and the like) is determinable locally. Prognostications regarding local conditions and weather are thereby enabled, whereby presence of ice and snow in particular places may be predicted, for example, and a user guided respectively. For example, a northern aspect where incidence of sunshine is unlikely for prolonged durations, determined to have experienced a temperature beneath or at freezing for a projected period, with understanding of a precipitation event recorded previously, may be determined as likely having presence of ice and snow whereby a user may be directed away from said area or via a different designated path, as will be discussed subsequently below.

The user is directed by action of a signal alarm issued at future user locations ascertained relative the current user location. Signal alarms may be audible, visual (for some users), or haptic. Audible signal alarms may present verbal instructions to the user, or issue sonorous sounds in identifiable sequences whereby an associated action may be prompted to be undertaken. Thus a user may walk a given direction until reaching a determined future user location, such as for example, an intersection, whereupon the signal alarm is issued to direct the user to turn left, for example, and continue along the designated path. Alternately, the signal alarm may arrest the user at the intersection, for example, and await changing of the traffic signal whereby safe passage is signaled to the user by issuance of another signal alarm.

In an example embodiment of the present invention contemplated herein, at least one vibration motor is disposed in operational communication with the user at least one peripheral device. The vibration motor is caused to vibrate in distinct patterns—in frequency, amplitude, even location in contact with the user's body—whereby vibrational stimuli contacting the user communicate directions to control the user's velocity. A plurality of vibration motors is contemplated ported by the user. In an example embodiment, the plurality of vibration motors is integrated in apparel, such as in the user's shoes, belt, wrist bands, eyewear, or headwear, for example. Additionally, vibration motors may be included in sporting equipment (such as ski pole handles, for example) or other portable accouterments by which directional signification may be signaled to the user holding said sporting equipment or accouterments, as case may be.

As an example, consider a plurality of vibration motors disposed in the insoles of a user's shoes. The plurality of vibration motors is disposed in a particular array in each insole and thereby indicative of a particular position in spatial relationship relative to the user. As the user walks along a street, for example, vibrations in vibration motors along the longitudinal arch of the user's left foot, for example, might signal presence of a building to the user's left, say. When reaching an intersection, vibration motors disposed underlying the user's toes, for example, might signal an arrest command, such as a pulse or specific sequence of short vibrations communicating to the user the need to arrest forward travel. The user thus is informed to stop. When the traffic signal changes, and it is safe to enter the crosswalk, the vibration motors might then signal a “go” command, by another unique sequence of vibrations—perhaps three short bursts, for example, of particular ones of the plurality of vibration motors. Frequency and amplitude of vibration may likewise indicate proximity—with distance to a sensed or known object signaled inversely proportionately to the frequency of vibrations experienced. Thus a range of proximity and alerts to approaching danger are communicable.

Thus the plurality of vibration motors may signal proximity to known or sensed objects and alert the user preventatively to enable avoidance of said objects. The signal alarm may therefore effect signals interpretive of directions to the user as well as signals preventative of collision. The signal alarms may likewise provide inference as to the surroundings, frequency of vibration may be paired with proximity to a known object or target, for example. Vibration may move between vibration motors to signal a user is moving by an object. Thus objects may be felt as moving around the user, relative to the user's movements, as signaled by the signal alarm.

Landscape data is constantly verified in the proximal environment whereby moveable or novel objects are discovered and positioned appropriately therein. Landscape data, in addition to population from the GDS, is capturable locally from third-party peripherals and the “internet-of-things”—networked everyday objects capable of transmitting data over network. Thus security cameras, traffic cameras, third-party peripherals and wirelessly communicating devices (“WCDs”) may be used to capture landscape data and update the GDS when objects are determined to have been moved or when a novel object is discovered. Multiple peripherals are usable to determine exact positioning and to verify a change of place of an object or determine situation of a novel object discovered in the proximal environment. Additional landscape data is generable over network by interfacing with weather stations, traffic schedules, GPS data, travel data, smart car data, and other data accessible over network.

Vehicular traffic may be made sensible to the system by local capture of landscape data in the manner previously described or by interfacing smart car data generated by individual vehicles over network to inform the system of the location, presence, and absence of vehicles. Additional sensing means are contemplated as part of this disclosure, including wearable peripherals ported by the user to effect interaction with objects, such as, for example, sonar, radar, infrared, and other waveform emissions by which discovery of particular spatial relationships is effective. Further, Near Field Communication (“NFC”) protocols may be enacted whereby the at least one user peripheral device communicates with objects within a field of view relative the user, whereby the signal alarm may be issued preventative of impact when a user is determined to be approaching an object within a specified range. Proximity to an object may be signaled, for example, by increasing frequency of the issuance of the signal alarm, whereby a user is alerted to a closing distance with potential for a collision.

Users may interact with the landscape data in some instances, whereby a user may select a location to memory such as, for example, a favorite designated path between frequented locations, a favorite restaurant, a particular park bench, or other such locations designable by interaction at the user at least one peripheral device. A visually impaired user may interact with the user at least one peripheral device by touching the screen (or particular buttons) in unique ways. Thus a single tap, as example, relative a rapid double tap may suffice to select in the alternative. Directional swiping and oral communication may likewise enable selection of data and navigation through menus, as case may be.

Third-party actors may also participate in verifying landscape data by enabling use of their peripheral devices as points of capture or by mapping an area and storing the mapped area to memory in the GDS. Thus a particular building, for example, or restaurant, say, my use a networked peripheral device to capture the interior space defining the interior of the building, room, business, or other such location, and enable a rendering of the room accessible to users practicing the present networked sensory enhanced navigation system. Verification of landscape data is nonetheless operative whereby changes in landscape data for any particular user location or proximal environment surrounding a user location are discoverable.

Visually impaired users are thus enabled navigation in real world environments and may be directed between user locations, as desired. Directions are comprehensible to the user by action of issuance of the signal alarm and users are prevented from collision with objects—even new objects unknown to the GDS—by verification procedures operative to update landscape data and continuously interface with the GDS whereby the signal alarm is issuable in response to real time stimuli effected in the proximal environment.

Thus has been broadly outlined the more important features of the present networked sensory enhanced navigation system so that the detailed description thereof that follows may be better understood and in order that the present contribution to the art may be better appreciated.

Objects of the present networked sensory enhanced navigation system, along with various novel features that characterize the invention are particularly pointed out in the claims forming a part of this disclosure. For better understanding of the networked sensory enhanced navigation system, its operating advantages and specific objects attained by its uses, refer to the accompanying drawings and description.

### BRIEF DESCRIPTION OF THE DRAWINGS

### Figures

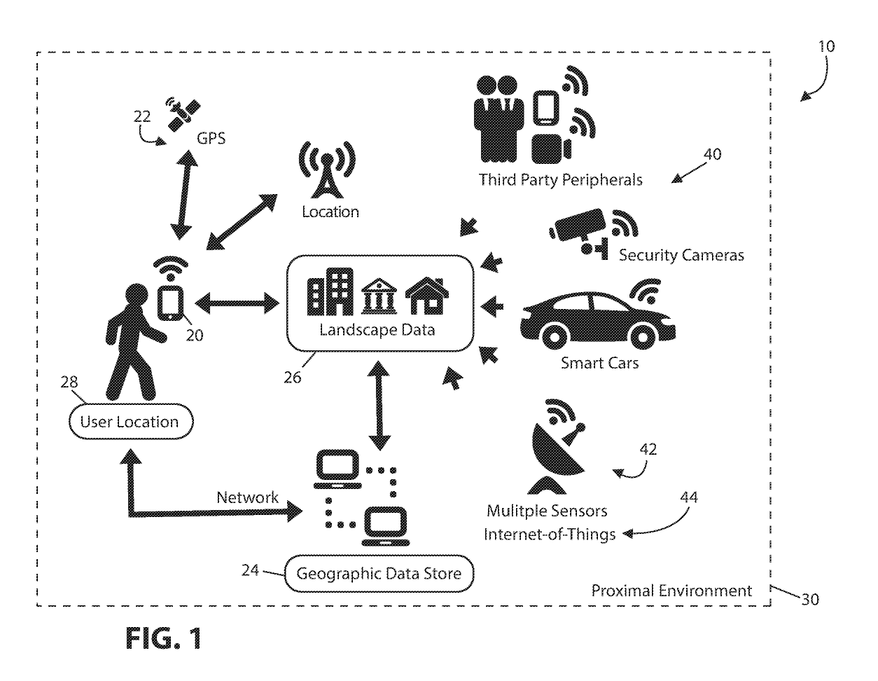

FIG. 1 is a diagrammatic view illustrating an example embodiment articulating landscape data informing a proximal environment.

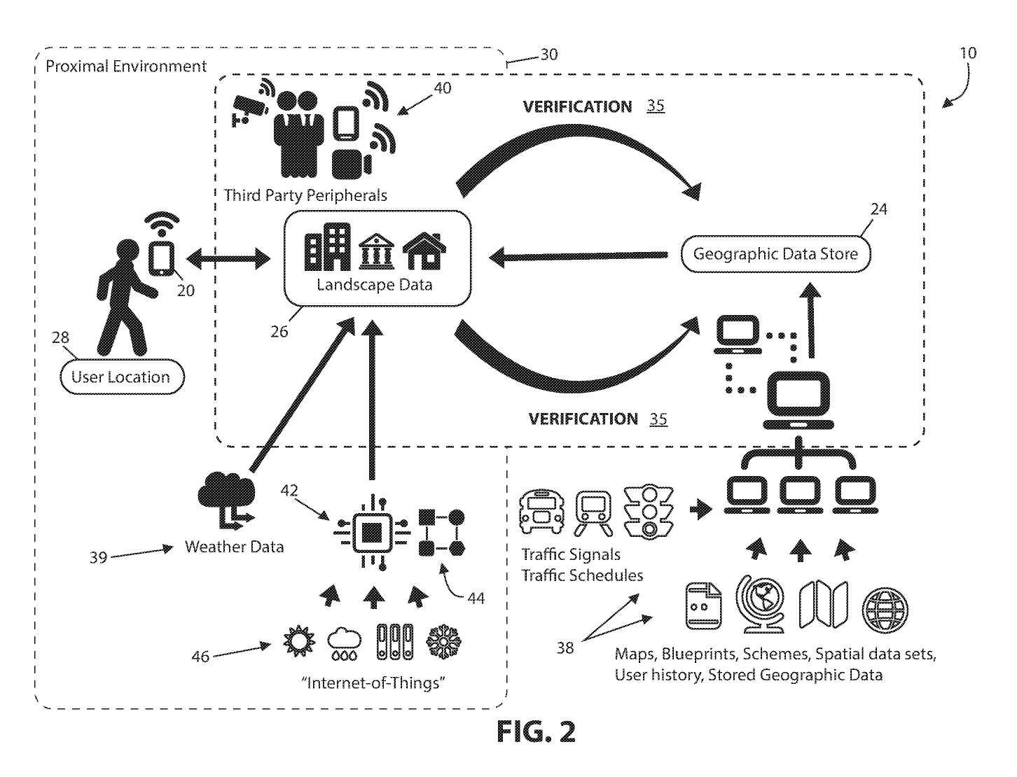

FIG. 2 is a diagrammatic view illustrating an example embodiment effecting verification and update of a Geographic Data Store by determination of local environmental conditions and capture of landscape data from third party peripherals active within the proximal environment.

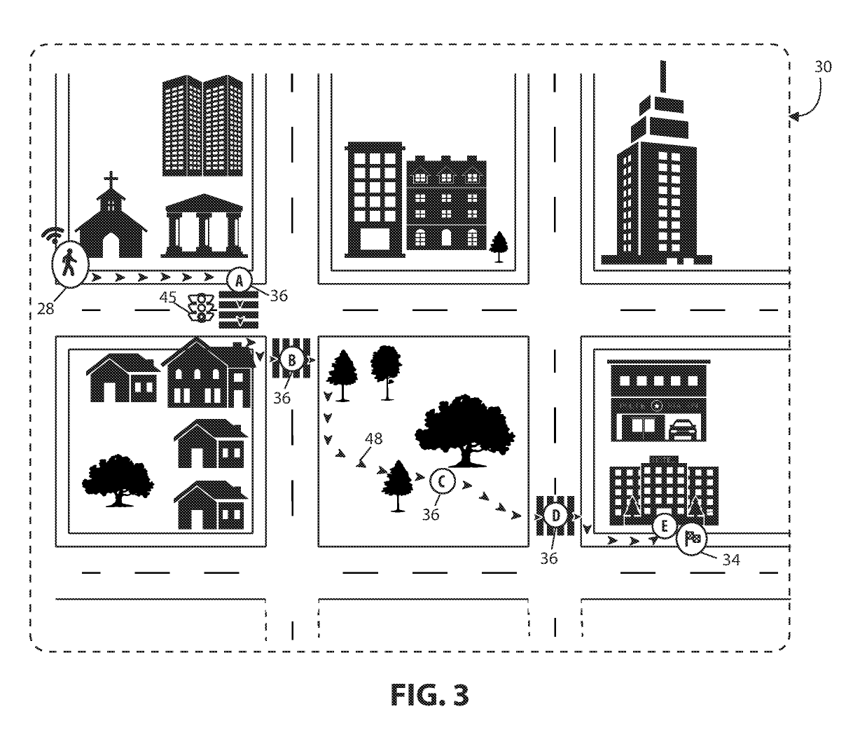

FIG. 3 is a diagrammatic view of an example embodiment of a designated path determined from a current user location towards a selected destination by way of a plurality of future user locations.

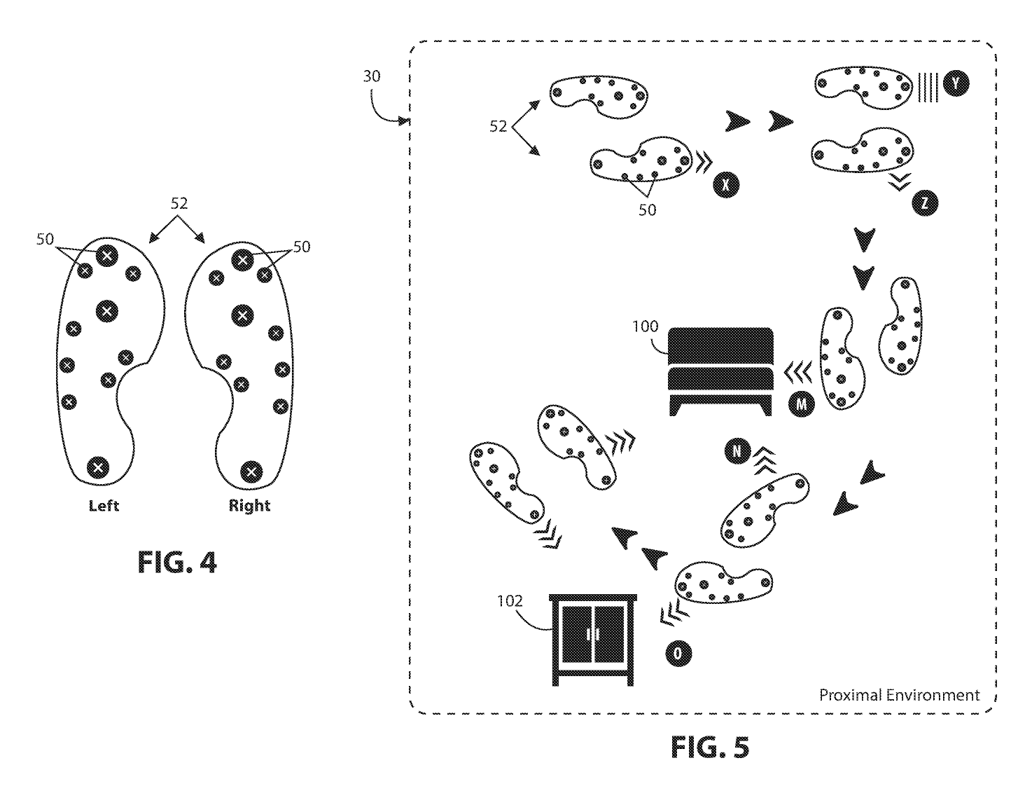

FIG. 4 is a diagrammatic view of an example embodiment of a plurality of vibration motors disposed in each of a user's pair of shoes.

FIG. 5 is a diagrammatic view of an example embodiment of unique issuances of a signal alarm communicating directions and presence of objects to be avoided.

### DETAILED DESCRIPTION OF THE DRAWINGS

The present networked sensory enhanced navigation system 10 has been devised to assist visually impaired users navigate in real time through a proximal environment 30. The present networked sensory enhanced navigation system 10 enables generation of landscape data 26 relative a current user location 28 to determine scope of a proximal environment 30 through which said user is traveling. Issuance of signal alarms 32 communicable to the user is effective to assist directing the user through the proximal environment 30, maintaining awareness of obstacles and objects that may otherwise impede travel. Users may therefore reach a desired destination 34 without having to visually interact with the proximal environment 30.

The present networked sensory enhanced navigation system 10, therefore, is operable in communication with at least one peripheral device 20 worn or carried by a visually impaired user. The term “visually impaired”, as used herein throughout, is taken to include users who are not presently capable of visioning the proximal environment 30 relative a user location 28 and is not necessarily limited to blind users, or partially bind users, but may also include users who are visually occupied, as for example, users wearing headsets that obstruct view.

As shown in FIG. 1, the at least one peripheral device 20 is disposed in network communication with a Global Positioning System (“GPS”) 22 whereby a user location 28 is determinable. GPS 22 may include triangulation of a signal between transceivers, as is possible between cellular communications towers, for example, or by interaction with other transceivers extant in the locale, or by satellite or repeating signal communications between available transceivers or additional sensors or other peripherals 40, and the at least one peripheral device 20. Additional means of determining user location 28 by sensed interaction with the peripheral device 20 are contemplated as part of this disclosure, as known in the art.

Geographic Data Store (“GDS”) 24 memory is accessible over network wherein landscape data 26 is storable and retrievable and continuous determination of a user location 28 is effective relative the proximal environment 30. Scope of said proximal environment 30 is generated by relative situation of objects known to be present in the proximal environment 30, as assessed by maps, blueprints, building plans, and other spatial data sets 38 and landscape data 26 as may be accessed through the GDS 24, as will be described subsequently (such as upload of data from participating peripheral devices not in hand or in use by the user in question). See FIG. 2. In proximal environments 30 where landscape data 26 is changeable, sensed objects may be determined to be present in said proximal environment 30, whereby landscape data 26 is updateable to inform the proximal environment 30 in real time.

Signal alarms 32 perceptible to the user are issued by at least one of the at least one peripheral device 20. These signal alarms 32 are communicative to direct the user through the proximal environment 30 sensible of the known or sensed objects determined present in the proximal environment 30, whereby avoidance of objects is maintained and unobstructed passage through the proximal environment 30 is enabled.

As shown in FIG. 2, Landscape data 26 may include, for example, maps, plans, blueprints, transportation schedules, among other available data accessible via network 38 and determined to be pertinent to the proximal environment 30 surrounding the relevant user location 28. Thus a proximal environment 30 interior to a particular building is comprehensible by access to building plans storable in the GDS 24 corresponding to the user location 28. Similarly a proximal environment 30 outside in a particular area is comprehensible by access to maps storable in the GDS 24 corresponding to the user location 28. See FIG. 2.

Thus, accessing the GDS 24 enables computation of a virtual representation of the field of view surrounding the user, the current user location 28, and prognostication of future user locations 36 based on the user location 28 and a sensed user velocity. As shown in FIG. 2, capture of the proximal environment 30 by one of the at least one peripheral device 20 may verify 35 the landscape data 26 as accessed by the GDS 24 and update the GDS 24 to include determination of unique objects sensed within the proximal environment 30 otherwise unknown in the relevant landscape data 26. Thus, moveable objects discovered in a new position relative known landscape data 26 stored in the GDS 24 for the current user location 28, for example, are thereby relocated by the system 10. New objects unknown to the GDS 24 are thence populated to the GDS 24 when discovered. See FIG. 2.

Capture of the proximal environment 30 is contemplated as effective by visual capture (as by a camera, for example), sonar capture (by monitoring of ultrasonic emissions, for example), infrared (by monitoring of electromagnetic emissions in the infrared spectrum, for example), or other waveform emission (such as radar, for example), as known in the art. Capture of the proximal environment 30 may be effected by at least one of the at least one peripheral device 20 in use by the user in question, or may be effected by additional peripheral devices 40, 44 found operating in the proximal environment 30, such as, for example, third party peripherals 40 or “internet-of-things” 44 discovered in operation in the proximal environment 30. Thus three dimensional spatial analysis and positioning of objects is effective between at least two cooperating peripheral devices found operating in the proximal environment 30.

Third-party peripherals 40 include traffic cameras, security cameras, radio frequency identification chips as may be employed in objects as part of the present system or the “internet-of-things”, cameras or emitters in vehicles sensible by the present system, or handheld and other peripheral computing devices as may be in operation by third-party users active in the proximal environment 30. Thus scope of the proximal environment 30 may be effected by capture between a plurality of sensors 42 disposed operating in the proximal environment 30 and the GDS 24 accessed by the user at least one peripheral device 20 is updateable by real time acquisition of local landscape data 26. Situation of objects may be repeatedly verified by multiple views effected by more than one third-party peripheral 40, whereby confirmation and verification of object position is repeatedly known.

The present networked sensory enhanced navigation system 10 may make use of the “internet-of-things”, wherein everyday objects 44 are networked to the internet and able to communicate local environmental data 46 such as temperature, pressure, sounds and sights, and other data, captured by said everyday objects 44. Further, the “internet-of-things” will enable unique identifiers of such networked everyday objects 44 whereby location data of such objects 44 is determinable over network and computable by the present system 10 to generate locally accurate and updateable landscape data 26 informative of the GDS 24. NFC between the at least one user peripheral device 20 and said everyday objects 44 further assists in continuously monitoring and updating the user location 28.

Real time generation of landscape data 26, therefore, is contemplated whereby, for example, traffic patterns along streets or other conduits are determinable relative a current user location 28. Further, traffic signals, such as pedestrian walkways and traffic lights, may be networked with the present system 10 to enable communication to the user of safe passage across a roadway, street, or other vehicular causeway, for example (see FIGS. 2 and 3).

Additionally, local weather conditions are contemplated as determinable by the present system 10 whereby local conditions in the proximal environment 30 may be predicted. For example, at least one of the at least one peripheral device 20 in use by the user may sense ambient temperature, barometric pressure, relative humidity, and other metrics, and thereby determine environmental data 46 as may be useful to the user. The at least one peripheral device 20 may likewise determine such environmental data 46 via network, communicating with weather stations 39, for example, to determine precipitation at the user location, or at a future user location 36 towards which said user is determined to be traveling (such as if a user were to exit a building, for example). Thus precipitation is determinable, and presence of ice and/or snow upon the ground may be comprehended by sensors 42 communicating within the proximal environment 30, such as cameras and/or temperature and moisture sensors disposed in objects (including vehicles) active in the proximal environment 30. Additionally, climatic history accessible over network, user uploaded data, and spatial aspect of known locations in the proximal environment (such as northern aspects and shady areas) may enable determination of likelihood of presence of ice and snow whereby the user may be directed accordingly.

As shown in FIG. 3, the networked sensory enhanced navigation system 10 is capable of determining a designated path 48, computable through the proximal environment 30, towards a desired and selected destination 34. The user may select a desired destination 34, which the present system 10 will subsequently navigate said user towards, or the system 10 may act preventatively, preventing collision or contact with objects known and sensed within the proximal environment 30 relative said user's user location 28 and projected future user locations 36.

As shown in FIG. 3, the user location 28 orients the user within the proximal environment 30. In the simplified example illustrated in FIG. 3, the user is guided in a direction until reaching future location A whereat the user is directed to turn right and subsequently cross the road when the traffic signal 45, communicating over network with the at least one user peripheral 20, enables safe passage. The user then approaches future location B and is caused to again cross the road. The user then is directed through the park towards future location C, said user directed around trees and other objects as case may be. The user is then directed across crosswalk D and brought to the desired destination 34 by entering into the building at future location E.

Communication with the user along the designated path 48, or preventative of collision with objects, is effective by issuance of the signal alarm 32. The signal alarm 32 is effected as sequential issuances perceptible to the user, said sequential issuances uniquely expressed to communicate proximity to various objects, warning alerts, and to provide directions along the designated path 48. For example a specific sequence of issuances, determined by rhythm or number, frequency or amplitude, for example, may communicate presence of a particular object, say, or a direction recommended for travel towards a future user location 36. The signal alarm 32 may be issued audibly, and may include verbal instructions intelligible to the user issued as commands, for example, or sonorously emitted as specific sounds matchable with associated responses and actions to be undertaken by the user.

The signal alarm 32 may be communicated haptically, whereby a user is enabled perception of the signal alarm 32 by vibrations, for example, whereby particular presences and/or particular sequences of vibrations may communicate specific information, such as direction of travel, presence or absence of objects, arrival at a desired location, or a moment in time when an action should be undertaken (such as crossing the road, for example). In such an embodiment, as illustrated diagrammatically in FIGS. 4 and 5, it is contemplated that at least one vibration motor 50 be disposed in operational communication with the at least one peripheral device 20, said at least one vibration motor 50 dispositional in contact with a user as integrated, for example, within an item of apparel or piece of equipment, accouterment, or other portable object.

A plurality of vibration motors 50 may be used, situated in contact with the user in a plurality of locations, whereby vibration of any one of the plurality of vibration motors 50 may, for example, communicate proximity to an object or indicate a desired direction, or a preferential moment wherein to make a motion towards a future user location 36. Thus the present networked sensory enhanced navigation system 10 is usable to direct a user through a proximal environment 30 towards a future user location 36, or along the designated path 48 towards a desired destination 34, while protecting the user from impacts and collisions with known and sensed objects existing and operating in the proximal environment 30.

In one embodiment of the invention 10, illustrated diagrammatically in FIGS. 4 and 5, vibration motors 50 are disposed in each of a users shoes 52 whereby effect of the signal alarm 32 stimulates the user's feet in unique positions and arrays. Particular arrangements of vibration motors 50 enable multiform signal alarms 32 indicative of particular stimuli. Thus, for example, vibration of a leftmost vibration motor 50 might signal a user to turn left. Frequency of vibrations might signal approaching a future user location 36 whereat a second sequence of vibrations might indicate an action, such as a left turn, as example. Additionally, signal alarms 32 may be effected to represent proximity to objects, and frequency of vibrations may be inversely proportional to distance relative to each object. Thus a user may be made sensible that said user is passing by an object, for example, such as indicated by the signal alarm 32 moving across a plurality of vibration motors 50 along the outer longitudinal arch of said user's foot, for example. Continual generation of signal alarms 32 along a particular part of the user's body may, for example, indicate presence of a roadway or a wall adjacent said user. Additional sites of vibration motors 50 upon the user are contemplated as part of this invention 10, including, for example, upon each wrist, each foot, each leg, as part of eyewear or headwear, and as part of clothing worn upon the body, or some sporting equipment or accouterments ported by said user, for example. Directional significance of any signal alarm 32 may be projected as a position stimulated upon the body relative landscape data 26 informing the proximal environment 30, for example.

FIG. 4 illustrates an example of a plurality of vibration motors 50 disposed interior to each of a user's pair of shoes 52. In this example embodiment, vibration motors 50 are contemplated as integrated with an insole in each shoe 52. It should be obvious to anyone having ordinary skill in the art that such vibration motors 50 could be integrated with additional items of clothing, apparel, or sporting equipment (specifically, the handles of ski poles, for example, whereby visually impaired users may receive directional signals while skiing). FIG. 5 illustrates a simplified example of unique issuances of a signal alarm to provide directional instructions and alert the user to the presence of objects in the proximity. In FIG. 5 the proximal environment 30 is diagrammatically representative of an interior space, such as a room, for example. Objects 100, 102 are known from user history stored to the GDS. Thus the user is directed forwards by issuance of directional signal alarm X. User is alerted to arrest forwards velocity by issuance of arrest signal alarm Y. Issuance of directional signal alarm Z communicates to the user to turn right. Continuing on the user is alerted to object 100 by proximity signal alarm M. Proximity signal alarm N communicates to user that user is passing by object 100. Proximity signal alarm O communicates to user presence of another object whereby the user is directed between said objects 100, 102, and enabled clear passage through the proximal environment.

The at least one peripheral 20 further enables computations of user velocity relative said user location 28 and, in conjunction with available and updateable landscape data 26, enables predictions of a future user location 36. The present system 10 is thereby enabled to act preventatively. Further, when future locations 36 are generated relative a designated path 48, estimated arrival times are calculable and future designated paths 49 are calculable relative each said future user location 36 along the designated path 48. Thus a user may rapidly execute a side route, for example, while traveling along a designated path 48 towards a pre-selected destination 34.

The present networked sensory enhanced navigation system 10 is enabled for voice recognition whereby a user is enabled to verbally interact with the system 10 effective through the user peripheral device 20. Additionally, a Graphic User Interface (“GUI”) may present renditions of the proximal environment 30 to interact with landscape data 26. This enables third-party actors to update landscape data 26 in a particular proximal environment 30 by interacting manually with the GUI. Additionally users may select destinations by manual interaction with the GUI.

Visually impaired users are enabled interaction with the present networked sensory enhanced navigation system 10 by contacting a screen of the at least one peripheral device 20, or otherwise effecting contact with said peripheral device 20. Audible commands may then direct the user through menus and a single tap, for example, relative a double tap, for example, may allow for selection in the alternative. Alternately, a swipe in one direction relative a swipe in another direction may also allow for selection in the alternative. Additionally, the present networked sensory enhanced navigation system 10 enables visual capture of objects whereby a user may query presence of objects not communicated through action of the signal alarm 32. The present networked sensory enhanced navigation system 10 may relate information pertinent to the object when stored in the GDS, such as, for example, a building's address.

The present networked sensory enhanced navigation system 10 further enables tagging of objects, preferred routes, and favorite locations wherein a user is enabled oral input of qualifiers associated with particular geographic data and storable in the GDS 24 whereby a particular location, for example, may be tagged with metadata unique to the user such as, for example, preference towards a particular restaurant, shop, park, particular route of travel, or other object or location.

What is claimed is:

1. A networked sensory enhanced navigation system operable in communication with at least one peripheral device, said networked sensory enhanced navigation system comprising:
continuous determination of a user location;
determination of a proximal environment relative to said user location, said proximal environment generable by landscape data comprising known or sensed objects determined to be present in said proximal environment; and
issuance of signal alarms perceptible to the user, said signal alarms communicative to direct the user through the proximal environment sensible of the known or sensed objects determined present in the proximal environment;
wherein a visually impaired user is enabled comprehension of said user's surroundings and therefore unobstructed passage through the proximal environment.

2. The networked sensory enhanced navigation system of claim 1 wherein the user location is determined by a Global Positioning System and the proximal environment is generable from a Geographic Data Store comprising landscape data uploaded to define landscape features captured previously and pertinent to said user location, said landscape data generable by maps, plans, blueprints, transportation schedules, traffic signals, and other available data accessible via network and pertinent to the proximal environment.

3. The networked sensory enhanced navigation system of claim 2 wherein local capture of the proximal environment verifies the landscape data and updates the Geographic Data Store to include determination and position of novel and moveable objects sensed within the proximal environment.

4. The networked sensory enhanced navigation system of claim 3 wherein local capture of the proximal environment is reinforced by multiple sensors networked through the proximal environment, said multiple sensors including at least one of:
a camera disposed upon the user, sonar issued from the user, infrared issued from the user, static cameras disposed in situ such as traffic cameras and security cameras, cameras disposed upon third party objects and transports, radars, radio frequency identification chips disposed upon moveable and immoveable objects, traffic signal changes, third-party peripherals determined in use in the proximal environment, drones, satellites;
wherein said multiple sensors are accessible over network to determine local positions of objects sensible within the proximal environment.

5. The networked sensory enhanced navigation system of claim 4 wherein local capture of the proximal environment is effected in real time.

6. The networked sensory enhanced navigation system of claim 5 wherein ambient temperature data and local weather data are accessible over network whereby environmental conditions at specific locations are determinable in the proximal environment.

7. The networked sensory enhanced navigation system of claim 6 wherein a designated path is computable relative landscape data through the proximal environment towards a selected destination.

8. The networked sensory enhanced navigation system of claim 7 wherein computations of user velocity, destination, user location, and landscape data enable predictions of a future user location relative the designated path, whereby arrival times are calculable and future designated paths are calculable relative said future user location.

9. The networked sensory enhanced navigation system of claim 8 wherein the signal alarm is effected as sequential issuances perceptible to the user, said sequential issuances uniquely expressed to communicate proximity to various objects, to effect warning alerts, and to provide directions along the designated path.

10. The networked sensory enhanced navigation system of claim 9 wherein the signal alarm is communicated audibly.

11. The networked sensory enhanced navigation system of claim 10 wherein the signal alarm is communicated haptically.

12. The networked sensory enhanced navigation system of claim 11 wherein the signal alarm is communicated by action of at least one vibration motor portable by the user.

13. The networked sensory enhanced navigation system of claim 12 wherein the at least one vibration motor is disposed in an item of apparel.

14. The networked sensory enhanced navigation system of claim 13 wherein the at least one vibration motor is disposed within at least one shoe.

15. The networked sensory enhanced navigation system of claim 14 wherein a user is enabled to verbally interact with the system by action effective through the user peripheral device.

16. The networked sensory enhanced navigation system of claim 15 wherein non-visually impaired users may effect capture of local landscape data and update the Geographic Data Store to reflect present conditions in the proximal environment.
